(19) United States
(12) Patent Application Publication
(10) Pub. No.: US 2009/0107823 A1
(43) Pub. Date: Apr. 30, 2009

(54) Light-emitting keyboard

(75) Inventors: Chang-Chun Liu, Shenzhen (CN); Xiao-Lin Gan, Shenzhen (CN); Yu-Kuang Ho, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (Shenzhen) CO., LTD., Shenzhen City (CN); HON HAI PRECISION INDUSTRY CO., LTD., Tu-Cheng (TW)

(21) Appl. No.: 11/953,876

(22) Filed: Dec. 11, 2007

(30) Foreign Application Priority Data
Oct. 25, 2007 (CN) 200710202248.6

(51) Int. Cl. H01H 13/70; H01H 9/00

(52) U.S. Cl. 200/5 A; 200/314; 200/317

(57) ABSTRACT

A light-emitting keyboard includes an upper cover with a plurality of keystrokes, a printed circuit board (PCB) connected to a connector via a cable, a lower cover, and an electric luminescent (EL) plate connected to the PCB via a transformer. The transformer is configured for receiving power from the PCB. The EL plate is arranged between the upper cover and the lower cover. The upper cover and the keystrokes are made of transparent material.

### CROSS-REFERENCES TO RELATED APPLICATION

Relevant subject matter is disclosed in co-pending U.S. patent application entitled “LIGHT-EMITTING KEYBOARD”, filed on Nov. 29, 2007 with application Ser. No. 11/946,863, and assigned to the same assignee as this application.

### BACKGROUND

1. Field of the Invention

The present invention relates to keyboards, and particularly to a light-emitting keyboard.

2. Description of Related Art

A computer system includes many components, such as the central processing unit (or processor), temporary memory for storing program instructions (like random access memory, or RAM), a permanent storage device (such as a hard disk), and a variety of user interface devices, such as a video display, a keyboard, and a pointing device.

The keyboard may come in a variety of physical embodiments. Referring to FIG. 4, a conventional keyboard includes an upper cover 12 with a plurality of keystrokes 122, a rubber layer 14, a partitioning layer 16, a printed circuit board (PCB) 17 connected to the partitioning layer 16, and a lower cover 18. The PCB 17 is connected to a connector 174 via a cable 172 for coupling the keyboard to the computer system via the connector 174.

Keyboards are used in a variety of applications for entry of alphanumeric and other types of data into a computer system. But it is hard to use a keyboard in a dark or gloomy environment.

### SUMMARY

An embodiment of a light-emitting keyboard includes an upper cover with a plurality of keystrokes, a printed circuit board (PCB) connected to a connector via a cable, a lower cover, and an electric luminescent (EL) plate connected to the PCB via a transformer. The transformer is configured for receiving power from the PCB. The EL plate is arranged between the upper cover and the lower cover. The upper cover and the keystrokes are made of transparent material.

Other advantages and novel features of the present invention will become more apparent from the following detailed description of preferred embodiments when taken in conjunction with the accompanying drawings, in which:

### BRIEF DESCRIPTION OF THE DRAWINGS

FIG. 1 is an exploded view of a light-emitting keyboard in accordance with the present invention;

FIG. 2 is an assembled view of FIG. 1;

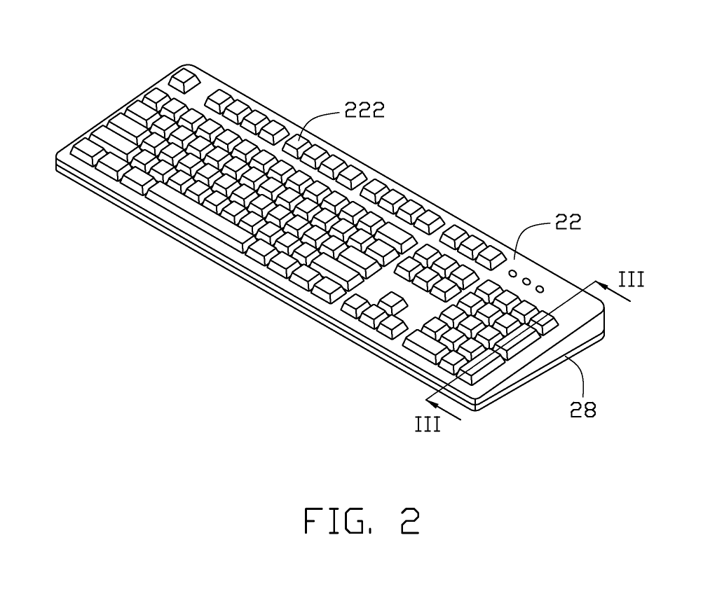

FIG. 3 is a cross-sectional view taken along line III-III of FIG. 2; and

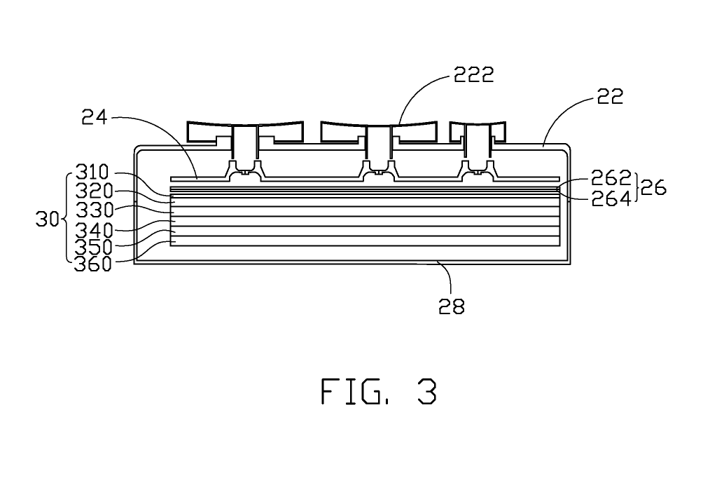

FIG. 4 is an exploded, isometric view of a conventional keyboard.

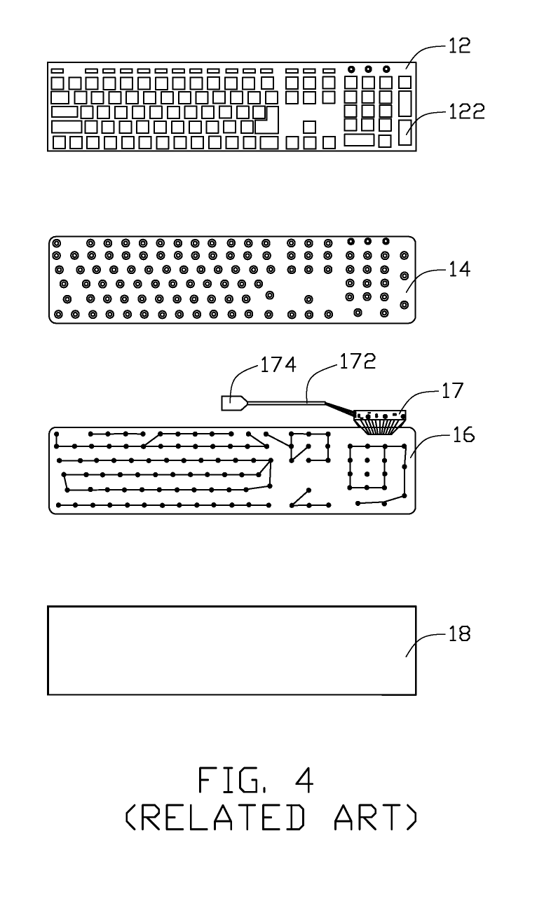

### DETAILED DESCRIPTION

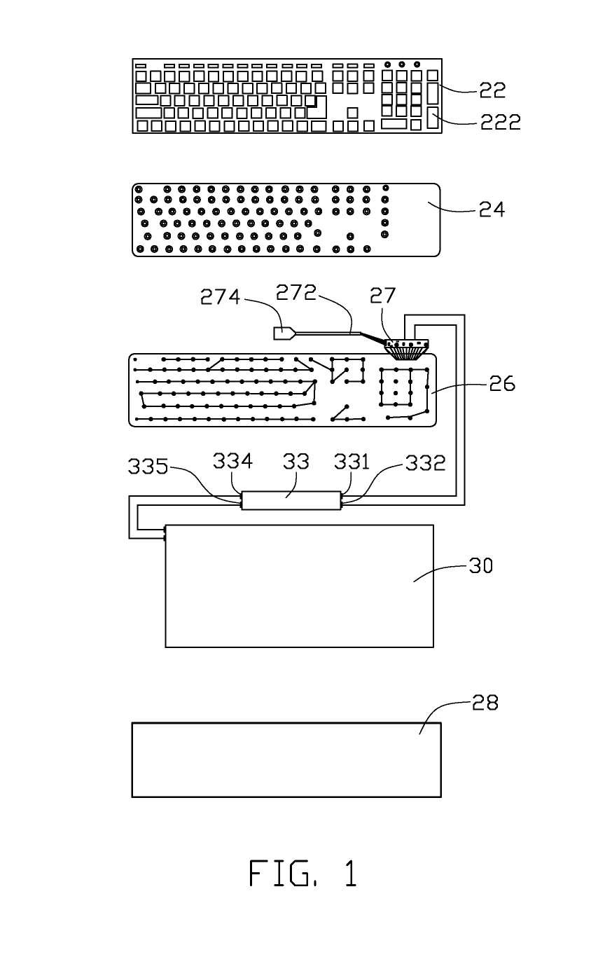

Referring to FIGS. 1˜3, a light-emitting keyboard in accordance with an embodiment of the present invention includes an upper cover 22 with a plurality of keystrokes 222, a rubber layer 24, a partitioning layer 26, a printed circuit board (PCB) 27 connected to the partitioning layer 26, an electric luminescent (EL) plate 30 connected to the PCB 27 via a transformer 33, and a lower cover 28 in turn. The transformer 33 includes two direct current (DC) input terminals 331 and 332 connected to two power terminals of the PCB 27, and two alternating current (AC) output terminals 334 and 335 connected to two power terminals of the EL plate 30. The PCB 27 is connected to a connector 274 via a cable 272 for coupling the light-emitting keyboard to a computer system via the connector 274. The upper cover 22, the keystrokes 222, the rubber layer 24, and the partitioning layer 26 are made of transparent material to permit transmission of light. In other embodiments, the PCB 27 is further coupled with a power connector (not shown) to connect the EL plate 30 to an external power supply when the keyboard is not hardwired to a computer system such as in the case of a wireless connection or merely to have the keyboard light up when the computer system is shut off for decorative purposes.

The EL plate 30 includes an upper insulating layer 310, a transparent electrode layer 320, a luminescent layer 330, a trigger layer 340, a lower electrode layer 350, and a lower insulating layer 360 in turn. In this embodiment, the upper insulating layer 310 is also a lower base layer of the partitioning layer 26. The partitioning layer 26 further includes an upper base layer 262 configured for arranging electronic elements thereon, and an isolation layer 264 arranged between the upper base layer 262 and the upper insulating layer 310. The isolation layer 264 defines a plurality of through holes for connecting some leads.

In use, the light-emitting keyboard is connected to a computer (not shown) via the connector 274. The transformer 33 receives DC power supply from the PCB 27 and transforms it to AC power for the EL plate 30. Then, the transparent electrode layer 320 and lower electrode layer 350 produce high speed electrons, and the high speed electrons strike the trigger layer 340, and then the trigger layer 340 triggers the luminescent layer 330 to emit light. Thus, the light-emitting keyboard can be used in a dark or gloomy environment, which is very convenient.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A light-emitting keyboard comprising:
an upper cover with a plurality of keystrokes;
a printed circuit board (PCB) connected to a connector via a cable;
a lower cover; and
an electric luminescent (EL) plate connected to the PCB via a transformer configured for receiving power from the PCB, the EL plate arranged between the upper cover and the lower cover, wherein the upper cover and the keystrokes are made of transparent material.

2. The light-emitting keyboard as claimed in claim 1, wherein the EL plate comprises an upper insulating layer, a transparent electrode layer, a luminescent layer, a trigger layer, a lower electrode layer, and a lower insulating layer in turn.

3. The light-emitting keyboard as claimed in claim 1, wherein further comprising a transparent rubber layer and a transparent partitioning layer between the upper cover and PCB.

4. A light-emitting keyboard comprising:
an upper cover with a plurality of keystrokes;
a printed circuit board (PCB) connected to a connector via a cable;
a lower cover; and
an electric luminescent (EL) plate connected to a transformer, the transformer connected to a power connector configured for receiving power from an external power supply, the EL plate arranged between the upper cover and the lower cover, wherein the upper cover and the keystrokes are made of transparent material.

5. The light-emitting keyboard as claimed in claim 4, wherein the EL plate comprises an upper insulating layer, a transparent electrode layer, a luminescent layer, a trigger layer, a lower electrode layer, and a lower insulating layer in turn.

6. The light-emitting keyboard as claimed in claim 4, wherein further comprising a transparent rubber layer and a transparent partitioning layer between the upper cover and PCB.
